(19) United States
(12) Patent Application Publication
(10) Pub. No.: US 2022/0049113 A1
(43) Pub. Date: Feb. 17, 2022

(54) POLYURETHANE COMPOSITION RAW MATERIAL LIQUID, POLYURETHANE COMPOSITION, AND MIXED DISCHARGE SYSTEM

(71) Applicant: SEKISUI CHEMICAL CO., LTD., Osaka (JP)

(72) Inventors: Shunji OHARA, Ageo-shi, Saitama (JP); Yuu KAKIMOTO, Kita-ku, Tokyo (JP); Tomonori KAJITA, Atsugi-shi, Kanagawa (JP)

(73) Assignee: SEKISUI CHEMICAL CO., LTD., Osaka (JP)

(21) Appl. No.: 17/312,655

(22) PCT Filed: Dec. 13, 2019
(86) PCT No.: PCT/JP2019/048996

§ 371 Date: Jun. 10, 2021

(30) Foreign Application Priority Data
Dec. 14, 2018 (JP) 2018-234206

(51) Int. Cl. C09D 5/18; C09D 175/06; C09D 5/02; C09D 7/61; C09D 7/45; C09D 7/65

(52) U.S. Cl. CPC C09D 5/18; C09D 175/06; C09D 5/021; B05C 9/06; C09D 7/45; C09D 7/65; C09D 7/61

(57) ABSTRACT

A polyurethane composition raw material liquid agent filled in a cartridge-like container comprises a polyol or a polyisocyanate, and a filler, wherein the polyurethane composition raw material liquid agent has a viscosity at 25° C. and a rotation speed of 10 rpm of 2300 mPa·s or more. The filler may include a solid flame retardant. The polyurethane composition raw material liquid agent and another polyurethane composition raw material liquid agent are mixed and discharged to form a polyurethane composition.

### TECHNICAL FIELD

The present invention relates to a polyurethane composition raw material liquid agent filled in a cartridge-like container, a polyurethane composition formed from this polyurethane composition raw material liquid agent and another polyurethane composition raw material liquid agent, and a mixing and discharge system comprising a cartridge-like container filled with the polyurethane composition raw material liquid agent.

### BACKGROUND ART

Generally, a polyurethane foam is formed by spraying a mixture of a polyol liquid agent including a polyol and a polyisocyanate liquid agent including a polyisocyanate with a large device such as a spray gun. For example, Patent Literature 1 discloses a urethane processing device for on-site foaming. This device includes a raw material feeding unit that pumps a liquid foaming raw material from each of two drum cans, a raw material reserve tank that temporarily stores and temperature-controls each of the liquid foaming raw materials from the raw material feeding unit, and a stirring and discharge unit that stirs, mixes, and discharges each of the liquid foaming raw materials. The polyol liquid agent and the polyisocyanate liquid agent stored in the drum cans are each stirred by a stirring blade immediately before use, and the sedimented components in the respective liquid agents are uniformly dispersed.

A polyurethane foam may be filled as a repair agent for small area defects that have occurred in vehicles, buildings, and the like. In that case, the polyol liquid agent and the polyisocyanate liquid agent are mixed and discharged by a compact device such as a caulking gun that can be easily worked on site. In a compact device such as a caulking gun, the polyol liquid agent and the polyisocyanate liquid agent are each filled in a cartridge-like container and stored at room temperature or low temperature for a long period of time.

### CITATION LIST

### Patent Literature

PTL1: JP 2000-141367 A

### SUMMARY OF INVENTION

### Technical Problem

In recent years, due to heightened awareness of disaster prevention, polyurethane foam used as a thermal insulator may be required to have high flame retardancy performance, and investigations are being carried out into blending a flame retardant having a high flame retardancy effect, even in liquid agents used in small devices. Most flame retardants having a high flame retardancy effect are in solid form, and are added to a liquid agent as a filler.

When a liquid agent is filled in a cartridge-like container mounted in a small device, in many cases the filler included in the liquid agent sediments at the bottom of the container. In a case where the filler has sedimented at the bottom of the container, it is necessary to stir the liquid agent to uniformly disperse the sedimented filler. It is not possible to stir a cartridge-like container filled with a liquid agent with a stirring blade for a large device immediately before use, and so a cartridge-like container filled with a liquid agent has to be stirred by manually shaking it. However, even if a cartridge-like container filled with both a polyol liquid agent and a polyisocyanate liquid agent is manually shaken, it is difficult to uniformly disperse the sedimented filler in each liquid agent.

Therefore, it is an object of the present invention to provide a polyurethane composition raw material liquid agent filled in a cartridge-like container and comprising a polyol or a polyisocyanate which can uniformly disperse a sedimented filler just by manually shaking.

### Solution to Problem

The present inventors have found that if the viscosity of a polyurethane composition raw material liquid agent which comprises a polyol or a polyisocyanate and a filler and which is filled in a cartridge-like container is increased to more than a predetermined level, sedimented filler can be uniformly dispersed just by manually shaking, to thereby complete the present invention.

The present invention provides the following polyurethane composition raw material liquid agent, a polyurethane composition formed using this polyurethane composition raw material liquid agent, and a mixing and discharge system comprising a cartridge-like container filled with the polyurethane composition raw material liquid agent.

[1] A polyurethane composition raw material liquid agent, comprising a polyol or an isocyanate, and a filler,

the polyurethane composition raw material liquid agent having a viscosity at 25° C. and a rotation speed of 10 rpm of 2300 mPa·s or more, and

the polyurethane composition raw material liquid agent is filled in a cartridge-like container.

[2] The polyurethane composition raw material liquid agent according to [1], further comprising an anti-sedimentation agent.
[3] The polyurethane composition raw material liquid agent according to [2], wherein the anti-sedimentation agent includes an anti-sedimentation agent having a thickening action.
[4] The polyurethane composition raw material liquid agent according to any one of [1] to [3], wherein the filler includes a solid flame retardant.
[5] The polyurethane composition raw material liquid agent according to [4], wherein the solid flame retardant is at least one selected from the group consisting of a red phosphorus flame retardant, a boron-containing flame retardant, a bromine-containing flame retardant, a phosphoric acid salt-containing flame retardant, a chlorine-containing flame retardant, an antimony-containing flame retardant, and a metal hydroxide.
[6] The polyurethane composition raw material liquid agent according to any one of [1] to [5], having a viscosity at 25° C. and a rotation speed of 10 rpm of 3300 mPa·s or more.
[7] The polyurethane composition raw material liquid agent according to any one of [1] to [6], having a viscosity at 25° C. and a rotation speed of 10 rpm of 4200 mPa·s or more.
[8] A polyurethane composition formed from a reaction product of the polyurethane composition raw material liquid agent according to any one of [1] to [7]
[9] The polyurethane composition according to [8], wherein the polyurethane composition forms a polyurethane foam.
[10] The polyurethane composition according to [8] or [9], wherein the polyurethane composition is used as a thermal insulator for a vehicle or a building.
[11] A mixing and discharge system comprising:

a first cartridge-like container filled with the polyurethane composition raw material liquid agent according to any one of [1] to [7]; and

a second cartridge-like container filled with another polyurethane composition raw material liquid agent.

[12] The mixing and discharge system according to [11], comprising a stationary mixer configured to mix the polyurethane composition raw material liquid agent discharged from the first cartridge-like container with the another polyurethane composition raw material liquid agent discharged from the second cartridge-like container.

### Advantageous Effects of Invention

In the polyurethane composition raw material liquid agent of the present invention, which is filled in a cartridge-like container, even if the filler sediments during long-term storage at normal temperature or low temperature, the sedimented filler becomes uniformly dispersed just by manually shaking.

### BRIEF EXPLANATION OF DRAWINGS

FIG. 1 is a schematic view illustrating an embodiment of a two-component cartridge-like container applied in the present invention.

FIG. 2 is a schematic view illustrating another embodiment of a two-component cartridge-like container applied in the present invention.

FIG. 3 is a schematic view illustrating another embodiment of a two-component cartridge-like container applied in the present invention.

FIG. 4 is a schematic view illustrating another embodiment of a two-component cartridge-like container applied in the present invention.

FIG. 5 is a schematic view illustrating another embodiment of a two-component cartridge-like container applied in the present invention.

FIG. 6 is a schematic view illustrating another embodiment of a two-component cartridge-like container applied in the present invention.

FIG. 7 is a schematic view illustrating another embodiment of a two-component cartridge-like container applied in the present invention.

FIG. 8 is a schematic view illustrating an embodiment of a mixing and discharge system of the present invention.

### DESCRIPTION OF EMBODIMENTS

[Polyurethane Composition Raw Material Liquid Agent]

A polyurethane composition raw material liquid agent of the present invention comprises a polyol or a polyisocyanate, and a filler. The polyurethane composition raw material liquid agent has a viscosity at 25° C. and a rotation speed of 10 rpm of 2300 mPa·s or more, and is filled in a cartridge-like container.

(Viscosity of Polyurethane Composition Raw Material Liquid Agent)

The polyurethane composition raw material liquid agent has a viscosity at 25° C. and a rotation speed of 10 rpm of 2300 mPa·s or more. If the viscosity is less than 2300 mPa·s, the filler included in the polyurethane composition raw material liquid agent will sediment and solidify at a lower portion of the cartridge-like container during long-term storage at normal temperature or low temperature, and the sedimented filler does not easily uniformly disperse even if the cartridge-like container is manually shaken. A preferable viscosity is 3300 mPa·s or more, a more preferable viscosity is 4200 mPa·s or more, and a further preferable viscosity is 4500 mPa·s or more. The upper limit of the viscosity is not particularly limited. If the viscosity is not excessively high, it is possible to prevent a problem that the liquid agent overflows due to an increase in internal pressure or the like when the cartridge is opened when the liquid temperature exceeds 40° C. Therefore, the viscosity is, for example, 7200 mPa·s or less.

In order to increase the viscosity at 25° C. and 10 rpm to 2300 mPa·s or more, for example, the filler content may be adjusted, or in the case of adding an anti-sedimentation agent, the amount of the anti-sedimentation agent may be adjusted. Further, for example, as a foaming agent or the like to be blended in the polyurethane composition raw material liquid agent, by selecting a foaming agent that has a low compatibility with the polyol or isocyanate to serve as the main component of the polyurethane composition raw material liquid agent, the viscosity of the polyurethane composition raw material is higher even when the number of parts added is the same. If the viscosity of the polyol or isocyanate is high, the viscosity of the polyurethane composition raw material liquid can be increased.

(Solid Content Concentration)

The polyurethane composition raw material liquid agent of the present invention preferably has a solid content concentration of 15 to 55% by mass. Here, the solid content is the component that remains after the polyurethane composition raw material liquid agent is removed by filtering, and refers to the insoluble matter that is not dissolved in the polyurethane composition raw material liquid agent. Details of the method for measuring the solid content concentration are as described in the Examples.

By setting the solid content concentration to 15% by mass or more, a certain amount or more of the filler, such as a solid flame retardant, is easily blended, and it is easier to improve the flame retardancy or the like of a polyurethane foam that is obtained. From the viewpoint of obtaining even better filler properties, such as flame retardancy, the solid content concentration is more preferably 17% by mass or more, and further preferably 20% by mass or more.

On the other hand, by setting the solid content concentration to 55% by mass or less, the polyurethane composition raw material liquid agent can be discharged at a high discharge flow rate, the miscibility between the two liquids is increased, and as a result the polyurethane foam has excellent various properties such as flame retardancy. From the viewpoint of improving the miscibility and further increasing the flame retardancy and the like, the solid content concentration is more preferably 40% by mass or less, and further preferably 35% by mass or less.

The polyurethane composition raw material liquid agent of the present invention contains a polyol or an isocyanate, and a filler, and further contains as appropriate an anti-sedimentation agent, a resinification catalyst, a trimerization catalyst, a foaming agent, water, a foam stabilizing agent, and the like.

For example, an example of the polyurethane composition raw material liquid agent of the present invention is a liquid agent including a polyol and a filler, as well as at least one further selected from the group consisting of an anti-sedimentation agent, a resinification catalyst, a trimerization catalyst, a foaming agent, water, and a foam stabilizing agent. In addition, an example of the polyurethane composition raw material liquid agent of the present invention is a liquid agent including an isocyanate and a filler, as well as at least one further selected from the group consisting of an anti-sedimentation agent, a foaming agent, and a foam stabilizing agent. Of these examples, a liquid agent including a polyol and a filler, as well as at least one further selected from the group consisting of an anti-sedimentation agent, a resinification catalyst, a trimerization catalyst, a foaming agent, water, and a foam stabilizing agent is preferable, and a liquid agent including a polyol and a filler, as well as an anti-sedimentation agent, a resinification catalyst, a trimerization catalyst, a foaming agent, water and a foam stabilizing agent is more preferable.

Hereinafter, each component used in the polyurethane composition raw material liquid agent of the present invention will be described in more detail. In the following description, the polyurethane composition raw material liquid agent including a polyol may be referred to as a polyol liquid agent, and the polyurethane composition raw material liquid agent including an isocyanate may be referred to as an isocyanate liquid agent.

The polyurethane composition raw material liquid agent of the present invention comprises a polyol or a polyisocyanate.

### (Polyol)

Examples of the polyol used in the present invention include a polylactone polyol, a polycarbonate polyol, an aromatic polyol, an alicyclic polyol, an aliphatic polyol, a polyester polyol, a polymer polyol, a polyether polyol, and the like.

Examples of the polylactone polyol include polypropiolactone glycol, polycaprolactone glycol, polyvalerolactone glycol, and the like.

Examples of the polycarbonate polyol include a polyol obtained by a dealcohol reaction between a hydroxyl group-containing compound, such as ethylene glycol, propylene glycol, butanediol, pentanediol, hexanediol, octanediol, and nonanediol, and ethylene carbonate, propylene carbonate, and the like.

Examples of the aromatic polyol include bisphenol A, bisphenol F, phenol novolac, cresol novolac, and the like.

Examples of the alicyclic polyol include cyclohexanediol, methylcyclohexanediol, isophoronediol, dicyclohexylmethanediol, dimethyldicyclohexylmethanediol, and the like.

Examples of the aliphatic polyol include ethylene glycol, propylene glycol, butanediol, pentanediol, hexanediol, and the like.

Examples of the polyester polyol include a polymer obtained by dehydration condensation of a polybasic acid and a polyhydric alcohol, a polymer obtained by ring-opening polymerization of a lactone such as ε-caprolactone and α-methyl-ε-caprolactone, and a condensate of hydroxycarboxylic acid and the polyhydric alcohol or the like.

Examples of the polybasic acid include adipic acid, azelaic acid, sebacic acid, isophthalic acid (m-phthalic acid), terephthalic acid (p-phthalic acid), succinic acid, and the like. Further, examples of the polyhydric alcohol include bisphenol A, ethylene glycol, 1,2-propylene glycol, 1,4-butanediol, diethylene glycol, 1,6-hexane glycol, neopentyl glycol, and the like.

Examples of the hydroxycarboxylic acid include castor oil, a reaction product of castor oil and ethylene glycol, and the like.

Examples of the polymer polyol include a polymer obtained by graft-polymerizing an ethylenically unsaturated compound such as acrylonitrile, styrene, methyl acrylate, and methacrylate with an aromatic polyol, an alicyclic polyol, an aliphatic polyol, a polyester polyol, or the like, a polybutadiene polyol, a modified polyol of a polyhydric alcohol, a hydrogenated product thereof, and the like.

Examples of the modified polyol of a polyhydric alcohol include a polyol modified by reacting the raw material polyhydric alcohol with an alkylene oxide, and the like.

Examples of the polyhydric alcohol include a trihydric alcohol such as glycerin and trimethylolpropane, tetra to octavalent alcohols such as pentaerythritol, sorbitol, mannitol, sorbitan, diglycerin, dipentaerythritol and the like, sucrose, glucose, mannose, fructose, methylglucoside, derivatives of these, and the like, polyols such as fluoroglucinol, cresol, pyrogallol, catechol, hydroquinone, bisphenol A, bisphenol F, bisphenol S, 1,3,6,8-tetrahydroxynaphthalene, and 1,4,5,8-tetrahydroxyanthracene, polyfunctional (for example, 2 to 100 functional groups) polyols such as castor oil polyol, a (co)polymer of hydroxyalkyl (meth)acrylate and a polyvinyl alcohol, a condensate of a phenol and formaldehyde (Novolak), and the like.

The method for modifying the polyhydric alcohol is not particularly limited, and a method for adding an alkylene oxide (hereinafter, also referred to as “AO”) can be preferably used. Examples of the AO include an AO having 2 to 6 carbon atoms, for example, ethylene oxide (hereinafter, also referred to as “EO”), 1,2-propylene oxide (hereinafter, also referred to as “PO”), 1,3-propylene oxide, 1,2-butylene oxide, 1,4-butylene oxide, and the like.

Among these, PO, from the viewpoint of properties and reactivity, PO, EO and 1,2-butylene oxide are preferable, and PO and EO are more preferable. When two or more kinds of AO are used (for example, PO and EO), the addition method may be block addition, random addition, or a combination of these.

Examples of the polyether polymer include a polymer obtained by subjecting at least one kind of alkylene oxide, such as ethylene oxide, propylene oxide, and tetrahydrofuran, to ring-opening polymerization in the presence of at least one kind of low-molecular-weight active hydrogen compound having two or more active hydrogens and the like. Examples of the low-molecular-weight active hydrogen compound having two or more active hydrogens include a diol such as bisphenol A, ethylene glycol, propylene glycol, butylene glycol, and 1,6-hexanediol, a triol such as glycerin and trimethylolpropane, an amine such as ethylenediamine and butylene diamine, and the like.

As the polyol used in the present invention, a polyester polyol and a polyether polyol are preferable. Further, a polyol having two hydroxyl groups is preferable. Among them, a polyester polyol obtained by dehydration condensation of a polybasic acid having an aromatic ring, such as isophthalic acid (m-phthalic acid) and terephthalic acid (p-phthalic acid), and a dihydric alcohol, such as bisphenol A, ethylene glycol, and 1,2-propylene glycol, is more preferable.

The polyol has a hydroxyl value of preferably 20 to 300 mgKOH/g, more preferably 30 to 250 mgKOH/g, and further preferably 50 to 220 mgKOH/g. When the hydroxyl value of the polyol is equal to or less the upper limit values, the viscosity of the polyurethane composition raw material liquid agent does not become excessively large, which is preferable from the viewpoint of handleability and the like. On the other hand, when the hydroxyl value of the polyol is equal to or more than the lower limit values, strength is increased due to an increase in the crosslinking density of the polyurethane foam.

The hydroxyl value of the polyol can be measured according to JIS K 1557-1: 2007.

(Polyisocyanate)

As the polyisocyanate used in the present invention, a known polyisocyanate used for forming polyurethane foam can be used. Examples of the polyisocyanate include an aromatic polyisocyanate, an alicyclic polyisocyanate, an aliphatic polyisocyanate, and the like.

Examples of the aromatic polyisocyanate include phenylene diisocyanate, tolylene diisocyanate, xylylene diisocyanate, diphenylmethane diisocyanate, dimethyldiphenylmethane diisocyanate, triphenylmethane triisocyanate, naphthalene diisocyanate, polymethylene polyphenyl polyisocyanate, and the like.

Examples of the alicyclic polyisocyanate include cyclohexylene diisocyanate, methylcyclohexylene diisocyanate, isophorone diisocyanate, dicyclohexylmethane diisocyanate, dimethyldicyclohexylmethane diisocyanate, and the like.

Examples of the aliphatic polyisocyanate include methylene diisocyanate, ethylene diisocyanate, propylene diisocyanate, tetramethylene diisocyanate, hexamethylene diisocyanate, and the like.

Among these, from the viewpoint of ease of use and availability, an aromatic polyisocyanate is preferable, and diphenylmethane diisocyanate is more preferable. One kind of polyisocyanate may be used alone, or two or more kinds may be mixed and used.

(Filler)

The filler preferably contains a flame retardant. By using flame retardant as a filler, a high flame retardancy performance can be imparted to the polyurethane foam.

The flame retardant used as a filler is a solid flame retardant. In the present invention, flame retardancy can be more effectively increased by using a solid flame retardant. Further, usually, the solid flame retardant is in a dispersed state as a solid component in the polyurethane composition raw material liquid agent, and constitutes at least a part of the above-described solid content (insoluble matter).

The solid flame retardant is a flame retardant that is a solid at normal temperature (23° C.) and normal pressure (1 atm).

From the viewpoint of effectively increasing the flame retardancy, the solid flame retardant is preferably at least one selected from the group consisting of a red phosphorus flame retardant, a boron-containing flame retardant, a bromine-containing flame retardant, a phosphoric acid salt-containing flame retardant, a chlorine-containing flame retardant, an antimony-containing flame retardant, a metal hydroxide, and an acicular filler, and more preferably is at least one selected from the group consisting of a red phosphorus flame retardant, a boron-containing flame retardant, a bromine-containing flame retardant, a phosphoric acid salt-containing flame retardant, a chlorine-containing flame retardant, an antimony-containing flame retardant, and a metal hydroxide.

<Red Phosphorus Flame Retardant>

The red phosphorus flame retardant may be composed of red phosphorus alone, but may also be red phosphorus coated with a resin, a metal hydroxide, a metal oxide, or the like, or may be a mixture of red phosphorus with a resin, a metal hydroxide, a metal oxide or the like. The resin that may coat the red phosphorus or mixed with red phosphorus is not particularly limited, and examples thereof include thermosetting resins such as a phenol resin, an epoxy resin, an unsaturated polyester resin, a melamine resin, a urea resin, an aniline resin, a silicone resin. As the compound to be coated or mixed, a metal hydroxide is preferable from the viewpoint of flame retardancy. The metal hydroxide may be appropriately selected and used from among those described later.

The amount of the red phosphorus flame retardant blended in the polyurethane composition raw material liquid agent is preferably 3 to 45 parts by mass, more preferably 14 to 40 parts by mass, further preferably 18 to 38 parts by mass, and particularly preferably 23 to 32 parts by mass, with respect to 100 parts by mass of the polyol or isocyanate. By setting the amount of the red phosphorus flame retardant blended to be not less than these lower limit values, the effect gained by containing the red phosphorus flame retardant is more easily exhibited. On the other hand, by setting the amount blended to be not more than these upper limit vales, foaming is not inhibited by the red phosphorus flame retardant.

<Boron-Containing Flame Retardant>

Examples of the boron-containing flame retardant used in the present invention include borax, a boron oxide, boric acid, a borate. Examples of the boron oxide include diboron trioxide, boron trioxide, diboron dioxide, tetraboron trioxide, tetraboron pentoxide.

Examples of the borate include a borate of an alkali metal, an alkaline earth metal, an element of Groups 4, 12, and 13 of the Periodic Table, and ammonium. Specifically, examples include an alkali metal borate salt such as lithium borate, sodium borate, potassium borate, and cesium borate, an alkaline earth metal borate salt such as magnesium borate, calcium borate, and barium borate, zirconium borate, zinc borate, aluminum borate, and ammonium borate.

The boron-containing flame retardant may be used alone or in combination of two or more.

The boron-containing flame retardant used in the present invention is preferably a borate, and more preferably zinc borate.

The amount of the boron-containing flame retardant blended in the polyurethane composition raw material liquid agent is not particularly limited, and is preferably 1 to 40 parts by mass, more preferably 3 to 20 parts by mass, further preferably 5 to 15 parts by mass, and particularly preferably 7 to 13 parts by mass, with respect to 100 parts by mass of the polyol or isocyanate. By setting the amount of the boron-containing flame retardant blended to be not less than these lower limit values, the effect gained by containing the boron-containing flame retardant is more easily exhibited and flame retardancy is increased. On the other hand, by setting the amount blended to be not more than these upper limit vales, foaming is not inhibited by the boron-containing flame retardant.

<Bromine-Containing Flame Retardant>

The bromine-containing flame retardant is not particularly limited as long as it is a compound that contains bromine in its molecular structure and that is a solid at normal temperature and pressure. Examples thereof include a brominated aromatic ring-containing aromatic compound.

Examples of the brominated aromatic ring-containing aromatic compound include monomer-based organic bromine compounds such as hexabromobenzene, pentabromotoluene, hexabromobiphenyl, decabromobiphenyl, decabromodiphenyl ether, octabromodiphenyl ether, hexabromodiphenyl ether, bis(pentabromophenoxy)ethane, ethylenebis(pentabromophenyl), ethylenebis(tetrabromophthalimide), tetrabromobisphenol A.

Further, the brominated aromatic ring-containing aromatic compound may be a bromine compound polymer. Specifically, examples include a polycarbonate oligomer produced from brominated bisphenol A as a raw material, a brominated polycarbonate of a copolymer and the like of this polycarbonate oligomer and bisphenol A, a diepoxy compound produced by a reaction between brominated bisphenol A and epichlorohydrin. Further examples include a brominated epoxy compound such as a monoepoxy compound obtained by a reaction between a brominated phenol and epichlorohydrin, poly(brominated benzyl acrylate), a condensate of a brominated polyphenylene ether, a brominated bisphenol A, and a brominated phenol of cyanur chloride, a brominated(polystyrene), a poly(brominated styrene), a brominated polystyrene such as a crosslinked brominated polystyrene, a crosslinked or non-crosslinked brominated poly(-methylstyrene).

Further, the bromine-containing flame retardant may be a compound other than a brominated aromatic ring-containing aromatic compound, such as hexabromocyclododecane.

These bromine-containing flame retardants may be used alone or in combination of two or more. Further, among the above, a brominated aromatic ring-containing aromatic compound is preferable, and among them, a monomer-based organic bromine compound such as ethylene bis(pentabromophenyl) is preferable.

The amount of the bromine-containing flame retardant blended in the polyurethane composition raw material liquid agent is preferably 3 to 45 parts by mass, more preferably 14 to 40 parts by mass, further preferably 18 to 38 parts by mass, and particularly preferably 23 to 32 parts by mass, with respect to 100 parts by mass of the polyol or isocyanate. By setting the amount of the bromine-containing flame retardant blended to be not less than these lower limit values, the effect gained by containing the bromine-containing flame retardant is more easily exhibited. On the other hand, by setting the amount blended to be not more than these upper limit vales, foaming is not inhibited by the bromine-containing flame retardant flame retardant.

<Phosphoric Acid Salt-Containing Flame Retardant>

Examples of the phosphoric acid salt-containing flame retardant include a phosphate composed of a salt of various phosphoric acids, with at least one metal or compound selected from various phosphoric acids, metals of Group IA to IVB of the Periodic Table, ammonia, an aliphatic amine, an aromatic amine, and a heterocyclic compound including nitrogen in the ring.

The phosphoric acid is not particularly limited, and examples thereof include a monophosphoric acid, a pyrophosphoric acid, a polyphosphoric acid.

Examples of the metals of Group IA to IVB of the Periodic Table include lithium, sodium, calcium, barium, iron(II), iron(III), and aluminum.

Examples of the aliphatic amine include methylamine, ethylamine, diethylamine, triethylamine, ethylenediamine, piperazine. Examples of the aromatic amine include aniline, o-toluidine, 2,4,6-trimethylaniline, anisidine, 3-trifluoromethyl)aniline. Examples of the heterocyclic compound containing nitrogen in the ring include pyridine, triazine, melamine.

Specific examples of the phosphoric acid salt-containing flame retardant include a monophosphate such as aluminum triphosphate, a pyrophosphate, a polyphosphate. Here, the polyphosphate is not particularly limited, and examples thereof include ammonium polyphosphate, piperazine polyphosphate, melamine polyphosphate, ammonium amide polyphosphate, and aluminum polyphosphate.

One or more kinds of the above-described phosphoric acid salt-containing flame retardant can be used.

The amount of the phosphoric acid salt-containing flame retardant blended in the polyurethane composition raw material liquid agent is not particularly limited, and is 3 to 40 parts by mass, more preferably 5 to 35 parts by mass, and particularly preferably 10 to 30 parts by mass, with respect to 100 parts by mass of the polyol or isocyanate. By setting the amount of the phosphoric acid salt-containing flame retardant blended to be not less than these lower limit values, the effect gained by containing the phosphoric acid salt-containing flame retardant is exhibited more easily. On the other hand, by setting the amount blended to be not more than the upper limit values, foaming is not inhibited by the phosphoric acid salt-containing flame retardant.

<Chlorine-Containing Flame Retardant>

Examples of the chlorine-containing flame retardant include those commonly used in flame retardancy resin compositions, such as polynaphthalene chloride, chlorendic acid, dodecachlorododecahydrodimethanodibenzocyclooctene sold under the trade name of “Dechlorane Plus”.

The blended amount of the chlorine-containing flame retardant used in the present invention is not particularly limited, and is preferably 3 to 40 parts by mass, more preferably 5 to 35 parts by mass, and further preferably 10 to 30 parts by mass, with respect to 100 parts by mass of the polyol or isocyanate. By setting the amount of the chlorine-containing flame retardant blended to be not less than these lower limit values, the effect gained by containing the chlorine-containing flame retardant is more easily exhibited. On the other hand, by setting the amount blended to be not more than these upper limit vales, foaming is not inhibited by the chlorine-containing flame retardant.

<Antimony-Containing Flame Retardant>

Examples of the antimony-containing flame retardant include an antimony oxide, an antimonate, a pyroantimonate. Examples of antimony oxide include antimony trioxide and antimony pentoxide. Examples of the antimonate include sodium antimonate, potassium antimonate. Examples of the pyroantimonate include sodium pyroantimonate, potassium pyroantimonate.

The antimony-containing flame retardant may be used alone or in combination of two or more.

A preferable antimony-containing flame retardant used in the present invention is antimony trioxide.

The amount of the antimony-containing flame retardant blended in the polyurethane composition raw material liquid agent is not particularly limited, and is preferably 1 to 40 parts by mass, more preferably 2 to 35 parts by mass, and further preferably 3 to 30 parts by mass, with respect to 100 parts by mass of the polyol or isocyanate. By setting the amount of the antimony-containing flame retardant blended to be not less than these lower limit values, the effect gained by containing the antimony-containing flame retardant is more easily exhibited and flame retardancy is increased. On the other hand, by setting the amount blended to be not more than the upper limit vales, foaming is not inhibited by the antimony-containing flame retardant.

<Metal Hydroxide>

Examples of the metal hydroxide used in the present invention include magnesium hydroxide, calcium hydroxide, aluminum hydroxide, iron hydroxide, nickel hydroxide, zirconium hydroxide, titanium hydroxide, zinc hydroxide, copper hydroxide, vanadium hydroxide, tin hydroxide. The metal hydroxide may be used alone or in combination of two or more.

The amount of the metal hydroxide blended in the polyurethane composition raw material liquid agent is, for example, 0.1 to 50 parts by mass, preferably 0.2 to 30 parts by mass, more preferably 0.3 to 20 parts by mass, and further preferably 0.5 to 15 parts by mass, with respect to 100 parts by mass of the polyol or isocyanate. By setting the amount of the metal hydroxide blended to be not less than these lower limit values, the effect gained by containing the metal hydroxide is more easily exhibited and flame retardancy is increased. On the other hand, by setting the amount blended to be not more than these upper limit vales, foaming is not inhibited by the metal hydroxide.

<Acicular Filler>

Examples of the acicular filler used in the present invention include potassium titanate whisker, aluminum borate whisker, magnesium-containing whisker, silicon-containing whisker, wollastonite, sepiolite, zonolite, ellestadite, boehmite, rod-shaped hydroxyapatite, glass fiber, carbon fiber, graphite fiber, metal fiber, slag fiber, gypsum fiber, silica fiber, alumina fiber, silica alumina fiber, zirconia fiber, boron nitride fiber, boron fiber, stainless steel fiber.

One or more of these acicular fillers can be used.

The acicular filler used in the present invention has an aspect ratio (length/diameter) that is preferably in a range of 5 to 50, and more preferably in a range of 10 to 40. The aspect ratio can be determined by observing the acicular filler with a scanning electron microscope and measuring the length and width.

The amount of the acicular filler blended in the polyurethane composition raw material liquid agent is, for example, 3 to 30 parts by mass, preferably 3 to 20 parts by mass, more preferably 3 to 18 parts by mass, and further preferably 6 to 18 parts by mass, with respect to 100 parts by mass of the polyol or isocyanate. By setting the amount of the acicular filler blended to be not less than the lower limit values, the shape of the polyurethane composition after combustion can be easily maintained. On the other hand, by setting the amount blended to be not more than the upper limit values, foaming of the polyurethane composition is less likely to be inhibited.

<Amount of Solid Flame Retardant Blended>

In the present invention, the amount of the solid flame retardant blended in the polyurethane composition raw material liquid agent is set to be not more than a certain amount, and the solid content concentration, the viscosity, or both, of the polyurethane composition raw material liquid agent are set to within the desired ranges. As a result, the polyurethane composition raw material liquid agent of the present invention can be discharged at a high discharge flow rate, and the miscibility with the another polyurethane composition raw material liquid agent for producing the polyurethane composition is also improved. In addition, the amount of sedimented filler in the polyurethane composition raw material liquid agent during storage is reduced, and the sediment can be uniformly dispersed just by manually shaking the cartridge-like container filled with the polyurethane composition raw material liquid agent. From such a viewpoint, the amount of the solid flame retardant blended in the polyurethane composition raw material liquid agent may be, for example, 150 parts by mass or less, preferably 90 parts by mass or less, more preferably 85 parts by mass or less, and further preferably 75 parts by mass or less, with respect to 100 parts by mass of the polyol or isocyanate.

On the other hand, by setting the amount of the solid flame retardant blended in the polyurethane composition raw material liquid agent to be not less than a certain amount, the solid flame retardant can impart an appropriate flame retardancy to the polyurethane foam. From such a viewpoint, the amount of the solid flame retardant blended is, for example, 20 parts by mass or more with respect to 100 parts by mass of the polyol or isocyanate. However, in order to sufficiently increase the flame retardancy by the solid flame retardant, the amount blended is preferably 30 parts by mass or more, more preferably 45 parts by mass or more, further preferably 55 parts by mass or more, and most preferably 60 parts by mass or more.

Further, as the filler, an inorganic filler other than the above-described flame retardant may also be blended. Examples of inorganic fillers that can be appropriate used include alumina, titanium oxide, calcium oxide, magnesium oxide, iron oxide, tin oxide, a ferrite, basic magnesium carbonate, calcium carbonate, magnesium carbonate, zinc carbonate, barium carbonate, dosonite, hydrotalcite, calcium sulfate, barium sulfate, calcium silicate, talc, clay, mica, montmorillonite, bentonite, active white clay, imogolite, cericite, glass beads, silica balloon, aluminum nitride, boron nitride, silicon nitride, graphite, carbon balloon, charcoal powder, various metal powders, magnesium sulfate, lead zirconate titanate, molybdenum sulfide, silicon carbide, various magnetic powders, fly ash. The inorganic filler may be used alone or in combination of two or more.

(Liquid Flame Retardant)

The flame retardant contained in the polyurethane composition raw material liquid agent preferably contains a liquid flame retardant in addition to the above-described solid flame retardant. A liquid flame retardant is a flame retardant that is a liquid at normal temperature (23° C.) and pressure (1 atmosphere). Specific examples of the liquid flame retardant include a phosphoric acid ester. By containing a liquid flame retardant in the polyurethane composition raw material liquid agent, sedimentation is less likely to occur during storage of the polyurethane composition raw material liquid agent of the present invention, and it is easier to improve the flame retardancy of the polyurethane composition raw material liquid agent of the present invention.

As the phosphoric acid ester, it is preferable to use a monophosphoric acid ester, a condensed phosphoric acid ester, or the like. Examples of the monophosphoric acid ester include a trialkyl phosphate such as trimethyl phosphate, triethyl phosphate, tributyl phosphate, and tri(2-ethylhexyl) phosphate, a halogen-containing phosphate such as tris(O-chloropropyl) phosphate, a trialkoxy phosphate such as tributoxyethyl phosphate, an aromatic ring-containing phosphoric acid ester such as tricresyl phosphate, trixylenyl phosphate, tris(isopropylphenyl) phosphate, cresyldiphenyl phosphate, and diphenyl(2-ethylhexyl) phosphate, an acidic phosphoric acid ester such as monoisodecyl phosphate and diisodecyl phosphate.

Examples of the condensed phosphoric acid ester include an aromatic condensed phosphoric acid ester such as trialkylpolyphosphate, resorcinol polyphenyl phosphate, bisphenol A polycredyl phosphate, and bisphenol A polyphenyl phosphate.

Examples of commercially available condensed phosphoric acid esters include “CR-733S”, “CR-741”, and “CR747”, which are manufactured by Daihachi Chemical Industry Co., Ltd., “Adeka Stub PFR” and “FP-600” manufactured by ADEKA.

As the liquid flame retardant, one kind of the above-described liquid flame retardants may be used alone, or two or more thereof may be used in combination. Among these, a monophosphoric acid ester is preferable, and tris(O-chloropropyl) phosphate is more preferable, from the viewpoint of facilitating production of the polyurethane foam by lowering the viscosity of the mixture of the polyurethane composition raw material liquid agent of the present invention and another polyurethane composition raw material liquid agent and the viewpoint of improving the flame retardancy of the polyurethane foam.

When the polyurethane composition raw material liquid agent of the present invention contains a liquid flame retardant, the amount of the liquid flame retardant blended in the polyurethane composition raw material liquid agent is preferably 5 to 70 parts by mass, more preferably 10 to 60 parts by mass, and further preferably 20 to 50 parts by mass, with respect to 100 parts by mass of the polyol or isocyanate. By setting the amount of the liquid flame retardant blended to be not less than these lower limit values, the effect gained by containing the liquid flame retardant is more easily exhibited. And, by setting the amount blended to be not more than these upper limit vales, foaming of the polyurethane foam is not inhibited by the liquid flame retardant.

Among the above-described solid flame retardants, it is preferable to use a red phosphorus flame retardant, a boron-containing flame retardant, and a bromine-containing flame retardant, and among them, it is preferable to use a red phosphorus flame retardant. By using a red phosphorus flame retardant, it is easier to further improve the flame retardancy.

Further, as the solid flame retardant, it is also preferable to use a red phosphorus flame retardant in combination with a solid flame retardant other than the red phosphorus flame retardant. In this case, the solid flame retardant other than the red phosphorus flame retardant may be one or more selected from the boron-containing flame retardant, the bromine-containing flame retardant, the phosphoric acid salt-containing flame retardant, the chlorine-containing flame retardant, the antimony-containing flame retardant, and the metal hydroxide, but it is preferably one or more selected from the boron-containing flame retardant and the bromine-containing flame retardant. By using the red phosphorus flame retardant in combination with boron-containing flame retardant or the bromine-containing flame retardant, it is even easier to further improve the flame retardancy.

In addition, from the viewpoint of flame retardancy, the solid flame retardant used in combination with the red phosphorus flame retardant is more preferably both the boron-containing flame retardant and the bromine-containing flame retardant.

Moreover, in the present invention, as described above, it is also preferable to use the solid flame retardant in combination with the liquid flame retardant. Therefore, as the flame retardant, it is preferable to use at least the red phosphorus flame retardant, which is a solid flame retardant, and the phosphoric acid ester, which is a liquid flame retardant.

From the viewpoint of flame retardancy, in addition to the red phosphorus flame retardant and the phosphoric acid ester, it is preferable to further use one or more selected from the phosphoric acid salt-containing flame retardant, the bromine-containing flame retardant, the chlorine-containing flame retardant, the antimony-containing flame retardant, the boron-containing flame retardant, and the metal hydroxide, and it is more preferable to further use one or more selected from the bromine-containing flame retardant and the boron-containing flame retardant.

Further, it is most preferable to use both the bromine-containing flame retardant and the boron-containing flame retardant in addition to the red phosphorus flame retardant and the phosphoric acid ester.

(Anti-Sedimentation Agent)

The polyurethane composition raw material liquid agent of the present invention preferably further contains an anti-sedimentation agent. The anti-sedimentation agent suppresses sedimentation of the filler dispersed in the polyurethane composition raw material liquid agent during long-term storage at normal temperature or low temperature, and makes it easier for the filler to be uniformly dispersed just by manually shaking the polyurethane composition raw material liquid agent. The anti-sedimentation agent is generally a solid at normal temperature and pressure, and is usually solid content (insoluble matter) in the polyurethane composition raw material liquid agent.

The anti-sedimentation agent is not particularly limited. Specific examples of the anti-sedimentation agent include powdered silica, organic clay, carbon black, hydrogenated castor oil wax, fatty acid amide wax. One or more of these are used.

As the powdered silica, fumed silica, colloidal silica, silica gel, and the like can be used. Among these, fumed silica is preferable, and hydrophobic fumed silica is particularly preferable. As the fumed silica, Aerosil (registered trademark) manufactured by Nippon Aerosil Co., Ltd., can be used.

As the organic clay, a phyllosilicate or the like having an affinity to organic matter can be used.

The carbon black produced by a method such as a furnace method, a channel method, or a thermal method may be used. A commercially available product may also be appropriately selected and used for the carbon black.

The hydrogenated castor oil wax, fatty acid amide wax, and the like form a swollen gel structure in a liquid.

These are generally commercially available under names such as a thixotropic agent, a thickening agent, an anti-sedimentation agent, an anti-dripping agent, and commercially available products can be appropriately selected and used.

A preferable anti-sedimentation agent is an anti-sedimentation agent having a thickening action, and among them, an anti-sedimentation agent including Si as an element constituting the anti-sedimentation agent is more preferable. Specific examples of the anti-sedimentation agent having a thickening action include fumed silica, and a phyllosilicate having an affinity to organic matter, and fumed silica is more preferable.

When the polyurethane composition raw material liquid agent of the present invention contains an anti-sedimentation agent, the content thereof is not particularly limited, and is, for example, 1 to 20 parts by mass, preferably 2 to 12 parts by mass, and more preferably 3.5 to 8 parts by mass, with respect to 100 parts by mass of the polyol or polyisocyanate. By setting the content of the anti-sedimentation agent to be not less than the lower limit values, the polyurethane composition raw material liquid agent can be thickened, thereby suppressing sedimentation of the filler, and enabling the dispersibility to be improved. Further, by setting the content of the anti-sedimentation agent to be not more than the lower limit values, the viscosity of the polyurethane composition raw material liquid agent is prevented from becoming excessively large, and a deterioration in handleability is prevented.

(Catalyst)

The polyurethane composition raw material liquid agent of the present invention preferably contains a catalyst. The polyurethane composition raw material liquid agent of the present invention may contain as the catalyst, for example, a resinification catalyst, a trimerization catalyst, or both, but it is preferable to contain both. It is good for these catalysts to be included when a polyol is used in the polyurethane composition raw material liquid agent of the present invention.

### <Resinification Catalyst>

The resinification catalyst is a catalyst that promotes the reaction between the polyol and the polyisocyanate. In the present invention, foaming catalysts that catalyze a reaction between water and the isocyanate are included in the meaning of resinification catalyst. Examples of the resinification catalyst include an amine-based catalyst such as an imidazole compound and a piperazine compound, and a metal-based catalyst,

Examples of the imidazole compound include a tertiary amine in which the secondary amine at the 1-position of the imidazole ring is replaced with an alkyl group, an alkenyl group, or the like. Specific examples include N-methylimidazole, 1,2-dimethylimidazole, 1-ethyl-2-methylimidazole, 1-methyl-2-ethylimidazole, 1,2-diethylimidazole, 1-isobutyl-2-methylimidazole. Further, an imidazole compound in which the secondary amine in the imidazole ring is replaced with a cyanoethyl group may be used.

In addition, examples of the piperazine compound include a tertiary amine such as N-methyl-N′,N′-dimethylaminoethylpiperazine and trimethylaminoethylpiperazine.

Examples of the amine-based catalyst include, in addition to the imidazole compound and the piperazine compound, various tertiary amines such as pentamethyldiethylenetriamine, triethylamine, N-methylmorpholinbis(2-dimethylaminoethyl)ether, N,N,N′,N″,N″-pentamethyldiethylenetriamine, N,N,N′-trimethylaminoethyl-ethanolamine, bis(2-dimethylaminoethyl)ether, N,N-dimethylcyclohexylamine, diazabicycloundecene, triethylenediamine, tetramethylhexamethylenediamine, tripropylamine.

Examples of the metal-based catalyst include a metal salt of lead, tin, bismuth, copper, zinc, cobalt, nickel, and the like, and preferably an organic acid metal salt of lead, tin, bismuth, copper, zinc, cobalt, nickel and the like. More preferably, examples include an organic acid tin salt such as dibutyltin dilaurate, dioctyltin dilaurate, and dioctyltin versatate, an organic acid bismuth salt such as bismuth trioctate and bismuth tris(2-ethylhexanoate). Among them, an organic acid bismuth salt is preferable.

The resinification catalyst may be used alone or in combination of two or more. Further, among the above, it is preferable to use one or more selected from 1,2-dimethylimidazole and bismuth tris(2-ethylhexanoate).

The content of the resinification catalyst is preferably 1 to 15 parts by mass, more preferably 2 to 10 parts by mass, and further preferably 3 to 8 parts by mass, with respect to 100 parts by mass of the polyol. When the content of the resinification catalyst is equal to or more than the lower limit values, a urethane bond tends to form, and the reaction proceeds rapidly. On the other hand, when the content is equal to or less than the upper limit values, the reaction rate is controlled more easily.

<Trimerization Catalyst>

The trimerization catalyst is a catalyst that promotes the formation of an isocyanurate rings by causing the isocyanate groups included in the polyisocyanate to react and trimerize. Examples of trimerization catalysts that can be used include a nitrogen-containing aromatic compound such as tris(dimethylaminomethyl)phenol, 2,4-bis(dimethylaminomethyl)phenol, and 2,4,6-tris(dialkylaminoalkyl)hexahydro-S-triazine, a carboxylic acid alkali metal salt such as potassium acetate, potassium 2-ethylhexanoate, and potassium octylate, a tertiary ammonium salt such as a trimethylammonium salt, a triethylammonium salt, and a triphenylammonium salt, a quaternary ammonium salt such as a tetramethylammonium salt, a tetraethylammonium salt, a tetraphenylammonium salt, a triethylmonomethylammonium salt, and a carboxylic acid quaternary ammonium salt. These may be used alone or in combination of two or more.

Among these, one or more selected from the group consisting of a carboxylic acid alkali metal salt and a carboxylic acid quaternary ammonium salt is preferable.

The content of the trimerization catalyst is 1 to 20 parts by mass, preferably 3 to 15 parts by mass, and more preferably 5 to 13 parts by mass, with respect to 100 parts by mass of the polyol. When the content of the trimerization catalyst is equal to or more than the lower limit values, trimerization of polyisocyanate occurs more easily, and the flame retardancy of the obtained polyurethane foam is improved. On the other hand, when the content of the trimerization catalyst is equal to or less than the upper limit values, the reaction is controlled more easily.

Further, the total content of the trimerization catalyst and the resinification catalyst in the polyurethane composition raw material liquid agent of the present invention is not particularly limited, and is preferably 2 to 35 parts by mass, more preferably 5 to 25 parts by mass, and further preferably 8 to 21 parts by mass, with respect to 100 parts by mass of the polyol. When the total content of both the catalysts in the polyurethane composition raw material liquid agent of the present invention is equal to or more than these lower limit values, the formation of urethane bonds and the trimerization proceed appropriately, and the flame retardancy of the polyurethane foam tends to be good. Further, when the total content of both the catalysts in the polyurethane composition raw material liquid agent of the present invention is equal to or less than these upper limit values, the urethanization and trimerization reactions are controlled more easily.

In the polyurethane composition raw material liquid agent of the present invention, a preferable range of the content of the resinification catalyst to the content of the trimerization catalyst is 1:1 to 1:50, a more preferable range is 1:1 to 1:20, and a further preferable range is 1:1 to 1:10. When the content of the trimerization catalyst/content of the resinification catalyst is equal to or more than the lower limit values, the formation of urethane bonds and trimerization proceed appropriately, and the flame retardancy of the polyurethane foam tends to be good. On the other hand, when the content of the trimerization catalyst/content of the resinification catalyst is equal to or less than the upper limit values, the stationary mixer is less likely to suffer from clogging due to curing of the mixture of the polyol liquid agent and the isocyanate liquid agent.

(Foaming Agent)

The polyurethane composition raw material liquid agent of the present invention preferably comprises a foaming agent. Examples of the foaming agent contained in the polyurethane composition raw material liquid agent include, but are not particularly limited to, a hydrofluoroolefin.

Examples of the hydrofluoroolefin include fluoroalkenes having 3 to 6 carbon atoms. Further, the hydrofluoroolefin may be a hydrochlorofluoroolefin having a chlorine atom, and therefore may be a chlorofluoroalkene or the like having 3 to 6 carbon atoms. The hydrofluoroolefin preferably has 3 or 4 carbon atoms.

More specifically, examples include trifluoropropene, a tetrafluoropropene such as HFO-1234, a pentafluoropropene such as HFO-1225, a chlorotrifluoropropene such as HFO-1233, chlorodifluoropropene, chlorotrifluoropropene, chlorotetrafluoropropene. More specifically, examples include 1,3,3,3-tetrafluoropropene (HFO-1234ze), 1,1,3,3-tetrafluoropropene, 1,2,3,3,3-pentafluoropropene (HFO-1225ye), 1,1,1-trifluoropropene, 1,1,1,3,3-pentafluoropropene (HFO-1225zc), 1,1,1,3,3,3-hexafluorobut-2-ene, 1,1,2,3,3-pentafluoropropene (HFO-1225yc), 1,1,1,2,3-pentafluoropropene (HFO-1225yez), 1-chloro-3,3,3-trifluoropropene (HFO-1233zd), 1,1,1,4,4,4-hexafluorobut-2-ene, 1,1,1,4,4,4-hexafluoro-2-butene (HFO-1336mzz). Of these, HFO-1233zd and HFO-1336mzz are preferable. In addition, from the viewpoint of handling properties due to boiling point and the like, HFO-1336mzz is particularly preferable.

These hydrofluoroolefins may be used alone or in combination of two or more.

The hydrofluoroolefin may be used alone, but may also be used in combination with one or more selected from a hydrocarbon and dimethyl ether.

The content of the foaming agent is preferably 10 to 60 parts by mass, more preferably 15 to 45 parts by mass, and further preferably 20 to 35 parts by mass, with respect to 100 parts by mass of the polyol or isocyanate. When the content of the foaming agent is equal to or more than the lower limit values, foaming is promoted and the density of the obtained polyurethane foam can be reduced. On the other hand, when the content of the foaming agent is equal to or less than the upper limit values, foaming can be suppressed from progressing excessively, and it is easier to increase the viscosity of the polyurethane composition raw material liquid agent.

(Water)

The polyurethane composition raw material liquid agent of the present invention may contain water. The inclusion of water improves the foaming property when forming the polyurethane foam. Water is included when a polyol is used in the polyurethane composition raw material liquid agent of the present invention.

The amount of water blended is, for example, 0.1 to 10 parts by mass, preferably 0.2 to 5 parts by mass, and more preferably 0.3 to 3 parts by mass, with respect to 100 parts by mass of the polyol. By setting the amount of water blended to be within these ranges, the polyurethane composition can be easily foamed appropriately.

(Foam Stabilizing Agent)

The polyurethane composition raw material liquid agent of the present invention preferably contains a foam stabilizing agent. The foam stabilizing agent improves the foaming property of the polyurethane composition obtained from the polyurethane composition raw material liquid agent and another polyurethane composition raw material liquid agent.

Examples of the foam stabilizing agent include a surfactant such as a polyoxyalkylene-based foam stabilizing agent, for example a polyoxyalkylene alkyl ether, a silicone-based foam stabilizing agent, for example an organopolysiloxane. These foam stabilizing agents may be used alone or in combination of two or more.

The amount of the foam stabilizing agent blended is preferably 0.1 to 10 parts by mass, more preferably 0.5 to 8 parts by mass, and further preferably 1 to 5 parts by mass, with respect to 100 parts by mass of the polyol or isocyanate. When the amount of the foam stabilizing agent blended is equal to or more than these lower limit values, the polyurethane composition, which is a reaction product of the polyurethane composition raw material liquid agent and the another polyurethane composition raw material liquid agent, can be easily foamed, and a homogeneous polyurethane foam can be easily obtained. Further, when the amount of the foam stabilizing agent blended is equal to or less than these upper limit values, the balance between the production cost and the obtained effect is good.

(Other Components)

The polyurethane composition raw material liquid agent of the present invention can optionally include, as long as the object of the present invention is not impaired, one or more selected from an additive such as a phenol-based, amine-based, sulfur-based or other antioxidant, a heat stabilizer, a metal damage inhibitor, an antistatic agent, a stabilizer, a cross-linking agent, a lubricant, a softener, a pigment, and a tackifying resin, a tackifier such as polybutene and a petroleum resin.

However, in the polyurethane composition raw material liquid agent of the present invention, it is desirable not to blend more solid components that are solid at normal temperature and pressure than necessary. It is preferable to reduce the amount of the solid components blended other than the above-described components as much as possible, and the amount blended should be less than the total amount of the solid flame retardant and the anti-sedimentation agent blended. The amount of the solid content blended of the components other than the above-described components (that is, the polyol, isocyanate, filler, flame retardant, anti-sedimentation agent, catalyst, foaming agent, water, and foam stabilizing agent,) is, for example, 10 parts by mass or less, preferably 5 parts by mass or less, and more preferably 1 part by mass or less, with respect to 100 parts by mass of the polyol or isocyanate.

(Method for Producing Polyurethane Composition Raw Material Liquid Agent)

The method for producing the polyurethane composition raw material liquid agent of the present invention is not particularly limited. For example, each component other than the foaming agent is mixed as necessary using Disper (disperser) or the like, the foaming agent is then added, the mixture is stirred, the volatile substances are removed, and the fact that the specified amounts are included in the liquid agent is confirmed. Next, the liquid agent may be produced by being filled into a cartridge-like container or other such container, and the container is sealed.

[Polyurethane Composition]

The polyurethane composition of the present invention is formed from a reaction product of the above-described polyurethane composition raw material liquid agent. That is, when the polyurethane composition raw material liquid agent includes a polyol, the polyurethane composition of the present invention is formed by reacting with another polyurethane composition raw material liquid agent including an isocyanate. Further, when the polyurethane composition raw material liquid agent includes an isocyanate, the polyurethane composition of the present invention is formed by reacting with another polyurethane composition raw material liquid agent including a polyol. At this time, the polyurethane composition raw material liquid agent and the another polyurethane composition raw material liquid agent to be reacted with the polyurethane composition raw material liquid agent may be mixed in a mass ratio such that the isocyanate index falls within a predetermined range as described later.

Further, the polyurethane composition is formed while foaming with the foaming agent contained in the polyurethane composition raw material liquid agent or a foaming agent contained in the another polyurethane composition raw material liquid agent to be reacted with the polyurethane composition raw material liquid agent, to thereby produce a polyurethane foam.

(Isocyanate Index)

The isocyanate index of the polyurethane composition of the present invention is not particularly limited, and is preferably 200 or more. When the isocyanate index is equal to or more than this lower limit values, the amount of polyisocyanate with respect to the polyol is in excess, so that isocyanurate bonds due to a polyisocyanate trimer tend to form, and as a result the flame retardancy of the polyurethane foam is improved. Further, when the isocyanate index is equal to or more than this lower limit values, it is easier to produce a polyurethane foam having isocyanurate bonds, that is, a polyurethane foam that combines a high level of flame retardancy with a high level of thermal insulation. From these viewpoints, the isocyanate index is more preferably 250 or more, further preferably 300 or more, and particularly preferably 350 or more.

Further, the isocyanate index is preferably 1000 or less, more preferably 800 or less, and particularly preferably 500 or less. When the isocyanate index is equal to or less than the upper limit values, the balance between the flame retardancy of the obtained polyurethane foam and the production cost is good.

The isocyanate index can be calculated by the following method.

Isocyanate index=equivalent amount of polyisocyanate−(equivalent amount of polyol+equivalent amount of water)×100

Here, each of the equivalent amounts can be calculated as follows.

Equivalent amount of polyisocyanate=amount of polyisocyanate used (g)×NCO content (% by mass)/molecular weight of NCO (mol)×100

Equivalent amount of polyol=OHV×amount of polyol used (g)−molecular weight of KOH (mmol)

OHV is the hydroxyl value (mgKOH/g) of the polyol.

Equivalent amount of water=amount of water used (g)/molecular weight of water (mol)×number of OH groups of water

In each of the above formulas, the molecular weight of NCO is 42 (mol), the molecular weight of KOH is 56100 (mmol), the molecular weight of water is 18 (mol), and the number of OH groups in water is 2.

(Cartridge-Like Container)

The “cartridge-like container” in the present invention is a container in which the polyurethane composition raw material liquid agent is filled in a sealed chamber in an unreacted state, and from which the raw material liquid agent can be discharged via an opening by some kind of method when forming the polyurethane composition. Two or more chambers are provided in one cartridge-like container, and two or more kinds of polyurethane composition raw material liquid agents can be filled therein (for example, two or more polyol liquid agents, two or more isocyanate liquid agents, or one or more polyol liquid agents and one or more isocyanate liquid agents). Further, one cartridge-like container may have only one chamber and may be filled with only one kind of polyurethane composition raw material liquid agent. The shape of the cartridge is not limited. The cartridge may function by being mounted in a device such as a caulking gun, or it may have a mechanism, such as a spray, in which the cartridge itself is a drive source. In addition, one side of the chamber may be movable, such as by a piston. The cartridge may have a pressure resistant structure so that the internal pressure can be increased.

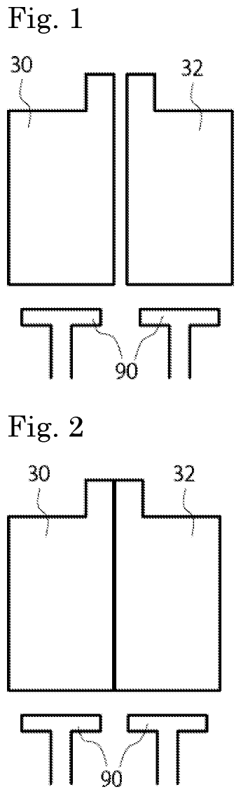

Here, when the cartridge-like container is a two-component cartridge-like container, the cartridge-like container may be configured such that during production of the polyurethane composition raw material liquid agent of the present invention, when filling the container and/or during storage, the polyurethane composition raw material liquid agent is separated from the another polyurethane composition raw material liquid agent, and the polyurethane composition raw material liquid agents are brought together from each container at the time of use, or the cartridge-like container may be formed such that the two cartridges are integrated originally. Examples of the structure of the cartridge-like container include those illustrated in FIGS. 1 to 7.

The two-component cartridge-like container illustrated in FIG. 1 includes a cartridge-like container 30 and a cartridge container 32 as separate bodies. Further, for example, the cartridge-like container 30 is filled with the polyurethane composition raw material liquid agent of the present invention, and the cartridge container 32 is filled with another polyurethane composition raw material liquid agent. For example, each of the liquid agents is extruded by an external force from a cylinder 90 or the like prepared separately from the cartridges.

It is noted that the “another polyurethane composition raw material liquid agent” is a term that includes cases where the liquid agent is the polyurethane composition raw material liquid agent of the present invention and cases where it is not. In addition, the polyurethane composition raw material liquid agent of the present invention and the another polyurethane composition raw material liquid agent may be collectively referred to as “the raw material liquid agents”.

In the example illustrated in FIG. 1, the two cartridge-like containers are separate bodies, but as illustrated in FIG. 2, the cartridge-like container 30 and the cartridge container 32 may be integrated. When the two cartridge-like containers are separate bodies as illustrated in FIG. 1, there is an advantage in that raw material liquid agents can be filled into each cartridge container depending on the situation, but if they are integrated as illustrated in FIG. 2, the two-component cartridge-like container can be made more compact.

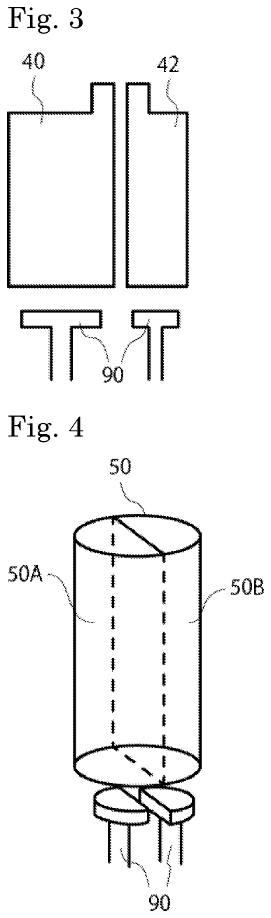

Further, in the example illustrated in FIG. 1, the two cartridge-like containers have the same shape, but as illustrated in FIG. 3, the shape of the containers may be changed to have different capacities. That is, the two-component cartridge-like container may be constructed from a cartridge-like container 70 and a cartridge container 72 having a smaller capacity than the cartridge-like container 70. By filling the cartridge-like container 70 with a raw material liquid agent having a large blending ratio and filling the cartridge-like container 72 with a raw material liquid agent having a small blending ratio, the cartridge-like containers can be replaced at the same time. The cartridge-like container 70 and the cartridge-like container 72 may also be integrated, as illustrated in FIG. 2.

Further, the two-component cartridge-like container may be constructed from one cartridge-like container. As illustrated in FIG. 4, a tubular cartridge-like container 50 is divided into two raw material liquid agent filling chambers 50A and 50B by a partition wall extending in the axial direction or the like, and for example, the raw material liquid agent filling chamber 50A may be filled with the polyurethane composition raw material liquid agent of the present invention and the raw material liquid agent filling chamber 50B may be filled with another polyurethane composition raw material liquid agent. With this configuration, the two-component cartridge-like container can be made more compact. The capacities of the raw material liquid agent filling chambers 50A and 50B may be the same or different.

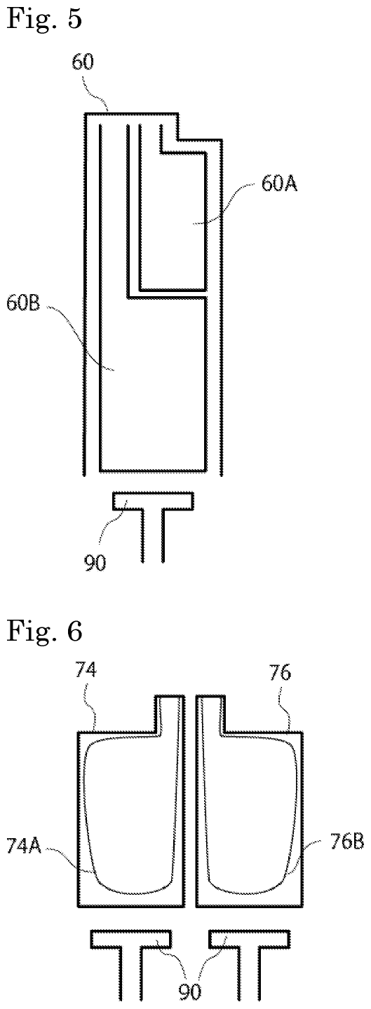

As another example of using a one cartridge-like container, as illustrated in FIG. 5, raw material liquid agent filling chambers 60A and 60B may be arranged vertically in a tubular cartridge-like container 60. Even with this configuration, a two-component cartridge-like container can be made more compact. In the case of FIG. 5, a pressing force is applied to the raw material liquid agent filling chamber 60B by a cylinder 90. The raw material liquid agent filling chamber 60B is pushed upward and comes into contact with a lower part of the raw material liquid agent filling chamber 60B, so that the pressing force by the cylinder 90 extends even to the liquid agent filling chamber 60B, and each of the raw material liquid agents is discharged. In the case of FIG. 5, the capacities of the raw material liquid agent filling chambers 60A and 60B may be the same or different.

It is desirable that each cartridge-like container be a rigid container made of a plastic such as polyethylene or polypropylene, and have a shape such as a columnar shape, a prismatic shape, or a semi-columnar shape. However, a flexible bag such as a pouch shape may also be used. When the container is made of a rigid material, the liquid agent in the container can be discharged by forming the surface to which an external force is to be applied by a cylinder or the like into a piston shape so that an external force can be applied.

When a flexible bag such as a pouch is used, as illustrated in FIG. 6, the two-component cartridge-like container may include two pouch-shaped bags 74A and 76A, each of which is filled with a raw material liquid agent. In the case of a pouch shape, the raw material liquid in the pouch can be discharged by squashing the pouch with an external force. However, to properly squash the pouch-shaped cartridge, it is preferable to provide guides 74 and 76 made of a rigid material around the pouch at the time of use. These guides may be supplied as a member of the cartridge, or may be provided in the design of the device or the like using the cartridge.

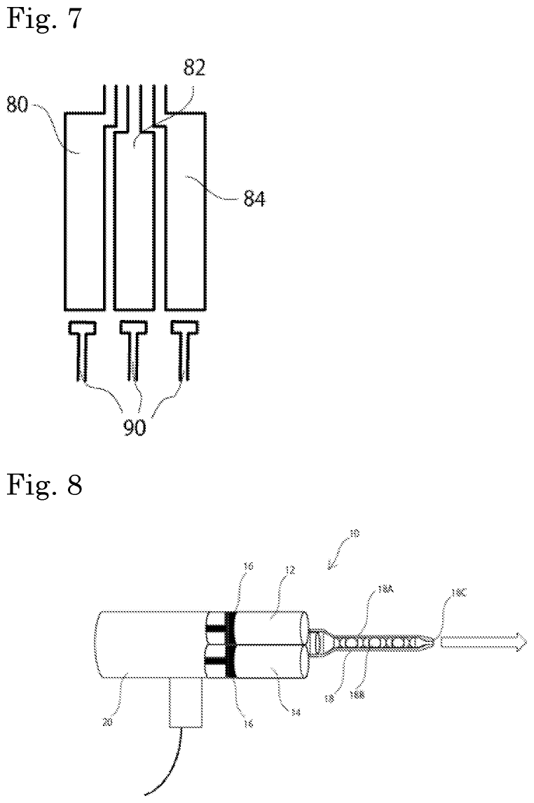

A case has been described above where the two-component cartridge-like container includes two raw material liquid filling sections, but the present invention is not limited to this, and there may be three or more raw material liquid filling sections. As illustrated in FIG. 7, the configuration may include three cartridge-like containers 80, 82, and 84. In this case, for example, two cartridge-like containers are filled with the polyurethane composition raw material liquid agent of the present invention, and one cartridge-like container is filled with another polyurethane composition raw material liquid agent. It is also noted that the three cartridge-like containers 80, 82, and 84 may be integrated, or two may be integrated but separated from the other one. The size of each of the cartridge-like containers may be the same or different.

In a preferred specific example, the polyurethane composition raw material liquid agent of the present invention is filled in at least one of the two-component cartridge-like containers comprising two cartridge-like containers. A specific example of a device including a two-component cartridge-like container is a caulking gun capable of mixing two components. Therefore, the polyurethane composition raw material liquid agent of the present invention may be filled in at least one cartridge-like container of a two-component-mixable caulking gun that includes a two-component cartridge-like container.

The polyurethane composition raw material liquid agent of the present invention filled in at least one of the cartridge-like containers of the caulking gun and another polyurethane composition raw material liquid agent are extruded separately, mixed in a mixing section, for example, and discharged from the caulking gun to produce the polyurethane composition of the present invention.

When the polyurethane composition raw material liquid agent of the present invention filled in one of the cartridge-like containers of the caulking gun is a polyol liquid agent including a polyol and a filler, the other polyurethane composition raw material liquid agent is an isocyanate liquid agent including an isocyanate. This isocyanate liquid agent may be of an embodiment of the polyurethane composition raw material liquid agent of the present invention.

When the polyurethane composition raw material liquid agent of the present invention filled in one of the cartridge-like containers of the caulking gun is an isocyanate liquid agent including a polyisocyanate and a filler, the other polyurethane composition raw material liquid agent is a polyol liquid agent including a polyol. This polyol liquid agent may be of an embodiment of the polyurethane composition raw material liquid agent of the present invention.

(Mixing and Discharge System)

The present invention also provides a mixing and discharge system for mixing a polyurethane composition raw material liquid agent with another polyurethane composition raw material liquid agent. One embodiment of this mixing and discharge system is the caulking gun illustrated in FIG. 8. Hereinafter, the caulking gun will be described with reference to FIG. 8.

As illustrated in FIG. 8, a mixing and discharge system 10 includes a first cartridge-like container 12 filled with the polyurethane composition raw material liquid agent of the present invention, and a second cartridge-like container 14 filled with another polyurethane composition raw material liquid agent that reacts with the polyurethane composition raw material liquid agent of the present invention to produce a polyurethane composition. The first and second cartridge-like containers 12 and 14 are incorporated in a caulking gun capable of mixing two components. The polyurethane composition raw material liquid agent extruded from the first cartridge and the another polyurethane composition raw material liquid agent extruded from the second cartridge-like container by a discharge mechanism of the caulking gun 20, for example, a piston 16 driven manually or by gas pressure, are mixed.

The mixing is carried out by driving the piston 16 manually or by an external force such as gas pressure to extrude the polyurethane composition raw material liquid agent in each of the first and second cartridge-like containers 12 and 14, and the polyurethane composition raw material liquid agents are mixed in the mixing section where they meet. Examples of the extrusion driving force of the two polyurethane composition raw material liquid agents include manually driving or gas pressure using a cylinder or a compressor. A preferable extrusion driving force is gas pressure. The use of gas pressure enables a stronger pressure to be stably applied than when manually driving, which contributes to an improvement in the miscibility of the polyurethane composition liquid agents and to a stabilization in the quality of the polyurethane composition liquid agents. The secondary pressure of the cylinder or compressor when using gas pressure is not particularly limited, and is preferably 0.05 MPa or more and 1 MPa or less, and more preferably 0.1 MPa or more and 0.7 MPa or less. By setting the secondary pressure to be not less than the lower limit values, the piston 16 can be reliably driven. Further, by setting the secondary pressure to be not more than the upper limit values, it is possible to prevent a sharp rise in the pressure in the first and second cartridge-like containers 12 and 14, which can cause the mixing of the two polyurethane composition raw material liquid agents to be insufficient and damage the containers.

The mixing section is a place where the polyurethane composition raw material liquid agent extruded from the first cartridge and the another polyurethane composition raw material liquid agent extruded from the second cartridge-like container are mixed, and is preferably a stationary mixer 18 called a static mixer.

The stationary mixer 18 does not have a drive unit, and mixes fluids by passing the fluids through the inside of a pipe. Examples of the stationary mixer 18 include a mixer in which a mixer element 18B is arranged inside a pipe 18A as illustrated in FIG. 8. The mixer element 18B may be, for example, formed in a spiral shape or may be formed from a plurality of baffle plates.

The stationary mixer 18 may also include a function of an injector. In that case, as illustrated in FIG. 8, the mixture mixed inside the pipe 18A may be injected from a tip 18C of the pipe.

In the above description of the mixing and discharge system, first and second cartridge-like containers are provided, and each container is filled with a polyol liquid agent or an isocyanate liquid agent. However, another mode may be used. In another mode, for example, at least two chambers may be provided in one cartridge-like container, and each of two types of polyurethane composition raw material liquid agent (polyol liquid agent and isocyanate liquid agent) may be filled in separate chambers. Even in that case, the cartridge-like container may be incorporated in a caulking gun, and a mixing section in which the polyol liquid agent and the isocyanate liquid agent filled in separate chambers are mixed may be provided as appropriate. These details of are as described above.

(Applications of Polyurethane Composition)

The polyurethane composition of the present invention can be used for various applications, but it is preferably used as a thermal insulator. Since the polyurethane composition constitutes a polyurethane foam, it has a large number of cells, and therefore has a thermal insulating effect.

In particular, it is more preferable to use the polyurethane composition as a thermal insulator for a vehicle or a building. The term vehicle includes rail carriages, automobiles, ships, aircraft, and the like. The polyurethane composition of the present invention has a high flame retardancy due to using the polyurethane composition raw material liquid agent described above. Therefore, from the viewpoint of disaster prevention and safety, the polyurethane composition of the present invention can be suitably used for vehicle or building applications.

The polyurethane composition of the present invention is formed using a caulking gun, for example, and is particularly suitable when the surface to be processed is relatively small. Therefore, for example, it is preferable to use the polyurethane composition raw material liquid agent of the present invention for a repair application in which a repair is performed by spraying the polyurethane composition raw material liquid agent onto a portion where an existing heat-resistant material has deteriorated or been damaged. Of course, the present invention is not limited to such applications, and the polyurethane composition raw material liquid agent of the present invention may be used for forming a new heat-resistant material.

### EXAMPLE

The present invention will now be described below in more detail with reference to examples, but the present invention is not limited thereto.

Each of the components used in the examples and comparative examples is shown below, and the content (parts by mass) of each component is shown in Table 1.

1) Polyol: Polyester polyol (Maximol RLK-087 manufactured by Kawasaki Kasei Chemicals, hydroxyl value=200 mgKOH/g)
2) Anti-sedimentation agent 1: Fumed silica (Aerosil R976S manufactured by Nippon Aerosil Co., Ltd.)
3) Anti-sedimentation agent 2: Phyllosilicate having an affinity to organic matter (GARAMITE-1958 manufactured by BYK)
4) Anti-sedimentation agent 3: Polyaminoamide polycarboxylic acid salt (ANTI-TERRA-204 manufactured by BYK)
5) Solid flame retardant 1: Red phosphorus flame retardant (Nova Excel 140 manufactured by Rin Kagaku Kogyo Co., Ltd., metal hydroxide coating, red phosphorus content 94% by mass or more)
6) Solid flame retardant 2: Zinc borate (Firebrake ZB manufactured by Hayakawa & Co., Ltd.)
7) Solid flame retardant 3: Ethylene bis(pentabromophenyl) (SAYTEX 8010 manufactured by Albemarle)
8) Liquid flame retardant: Tris(p-chloropropyl) phosphate (TMCPP manufactured by Daihachi Chemical Co., Ltd.)
9) Resinification catalyst 1: Carboxylic acid bismuth salt (U-600 manufactured by Nitto Kasei Co., Ltd., active ingredient 55 to 58% by mass, diluted with 2-ethylhexanoic acid)
10) Resinification catalyst 2: Imidazole compound (TOYOCAT-DM70 manufactured by Tosoh Corporation, active ingredient amount 65 to 75% by mass, diluted with ethylene glycol)
11) Trimerization catalyst 1: Carboxylic acid quaternary ammonium salt (DABCO TMR-7 manufactured by Evonik Japan Co., Ltd., active ingredient amount 45 to 55% by mass, diluted with ethylene glycol)
12) Trimerization catalyst 2: Potassium carboxylate (DABCO K-15 manufactured by Evonik Japan Co., Ltd., active ingredient approximately 75% by mass, diluted with ethanediol)
13) Foaming agent 1: HFO-1233zd (E) (Solstice LBA manufactured by Central Glass Co., Ltd.)
14) Foaming agent 2: HFO-1336mzz (Z) (Opteon 1100 manufactured by Chemours-Mitsui Fluoroproducts Co., Ltd.)
15) Foaming agent 3: Hydrofluoroolefin (Opteon 1150 manufactured by Chemours-Mitsui Fluoroproducts Co., Ltd.)
16) Foam stabilizing agent: Polyoxyalkylene-based foam stabilizing agent (manufactured by Dow Corning Toray, product name SH-193)

### Examples 1 to 9 and Comparative Examples 1 to 3

In accordance with the blends shown in Table 1, the components other than the foaming agent were measured into a 1000 ml polypropylene beaker, mixed at 1500 rpm for 5 minutes using Disper, then the foaming agent was added and mixing was further carried out. The amount of foaming agent remaining in the mixed solution was adjusted so as to finally be as shown in Table 1 to obtain a polyurethane composition raw material liquid agent. The viscosity of the obtained polyurethane composition raw material liquid agent was measured, each polyurethane composition raw material liquid agent was filled into a cartridge-like container as described below, and room temperature sedimentation and low temperature sedimentation were evaluated.

### (1) Viscosity of Polyurethane Composition Raw Material Liquid Agent

300 ml of the polyurethane composition raw material liquid agent was placed in a 300 ml polypropylene cup, and the value 1 minute after measuring the viscosity of the polyurethane composition raw material liquid agent at 25° C. and a rotation speed of 10 rpm using a B-type viscometer was recorded.

### (2) Solid Content Concentration

In the same manner as in the viscosity measurement, the foaming agent was volatilized, and then weight of the polyurethane composition raw material liquid agent and the weight of a filter paper (Circular quantitative filter paper No. 3, manufactured by Advantech) were measured. The weight of the filter paper was taken as W0, and the total weight of the polyurethane composition raw material liquid agent and the filter paper was taken as W1. The polyurethane composition raw material liquid agent was suction filtered using the filter paper. The residue on the filter paper was washed several times with acetone, and then the filter paper and the residue were allowed to dry for 30 minutes in suction-filtered state. The total weight of the dried filter paper and residue was weighed, and the value was taken as W2. The solid content concentration (% by mass) was calculated by {(W1−W2)/(W1−W0)}×100.

### (3) Room Temperature Sedimentation Evaluation

Approximately 130 g of polyurethane composition raw material liquid agent was filled in a cartridge-like container so as to avoid the insertion of an air layer, and the cartridge-like container was allowed to stand at 30° C. for 4 weeks with the piston on the lower side. After standing, the cartridge-like container was manually shaken 20 times, and two holes were made in an upper portion of the filled cartridge-like container. The cartridge-like container was tilted so that the upper portion was at an angle of 45 degrees diagonally downward, and the fluid polyurethane composition raw material liquid agent was discharged outside of the cartridge-like container. After confirming that there was no more polyurethane composition raw material liquid agent to be discharged, a cut was made in a transverse direction 5 cm from the bottom of the cartridge-like container, and the mass of the sediment remaining inside was measured. The following determination was made based on the mass at that time.

A: Less than 5 g
B: 5 g or more and less than 10 g
C: 10 g or more

### (4) Low Temperature Sedimentation Evaluation

In the same manner as the room temperature sedimentation evaluation, the polyurethane composition raw material liquid agent was filled in a cartridge-like container, the cartridge-like container was allowed to stand at 5° C. for 12 weeks, then moved to room temperature, and the liquid temperature was returned to 20° C. or more. Then, the amount of sediment was measured in the same manner as for the room temperature sedimentation evaluation, and the determination was made according to the above evaluation criteria.

TABLE 1

| | | | | | | | | | | | Com- | Com- | Com- |
|---|---|---|---|---|---|---|---|---|---|---|---|---|---|
| | | Exam- | Exam- | Exam- | Exam- | Exam- | Exam- | Exam- | Exam- | Exam- | parative | parative | parative |
| | | ple | ple | ple | ple | ple | ple | ple | ple | ple | Exam- | Exam- | Exam- |
| | | 1 | 2 | 3 | 4 | 5 | 6 | 7 | 8 | 9 | ple 1 | ple 2 | ple 3 |
| Polyurethane | Polyol | 100 | 100 | 100 | 100 | 100 | 100 | 100 | 100 | 100 | 100 | 100 | 100 |
| composition | Anti- | 3.6 | 3.6 | 3.6 | 3.9 | 4.2 | 4.6 | 3.9 | 3.6 | — | 2.9 | 3.3 | — |
| raw material | sedimentation | | | | | | | | | | | | |
| liquid agent | agent 1 | | | | | | | | | | | | |
| blend (parts by | Anti- | — | — | — | — | — | — | — | — | 6.8 | — | — | — |
| mass) | sedimentation | | | | | | | | | | | | |
| | agent 2 | | | | | | | | | | | | |
| | Anti- | — | — | — | — | — | — | — | — | — | — | — | 5.2 |
| | sedimentation | | | | | | | | | | | | |
| | agent 3 | | | | | | | | | | | | |
| | Solid flame | 26.1 | 26.1 | 26.1 | 26.1 | 26.1 | 26.1 | 26.1 | 26.1 | 26.1 | 26.1 | 26.1 | 26.1 |
| | retardant 1 | | | | | | | | | | | | |
| | Solid flame | 9.8 | 9.8 | 9.8 | 9.8 | 9.8 | 9.8 | 9.8 | 9.8 | 9.8 | 9.8 | 9.8 | 9.8 |
| | retardant 2 | | | | | | | | | | | | |
| | Solid flame | 29.3 | 29.3 | 29.3 | 29.3 | 29.3 | 29.3 | 29.3 | 29.3 | 29.3 | 29.3 | 29.3 | 29.3 |
| | retardant 3 | | | | | | | | | | | | |
| | Liquid flame | 39.1 | 39.1 | 39.1 | 39.1 | 39.1 | 39.1 | 39.1 | 39.1 | 39.1 | 39.1 | 39.1 | 39.1 |
| | retardant | | | | | | | | | | | | |
| | Resinification | 2.6 | 2.6 | 2.6 | 2.6 | 2.6 | 2.6 | 2.6 | 2.6 | 2.6 | 2.6 | 2.6 | 2.6 |
| | catalyst 1 | | | | | | | | | | | | |
| | Resinification | 5.2 | 5.2 | 5.2 | 5.2 | 5.2 | 5.2 | 5.2 | 5.2 | 5.2 | 5.2 | 5.2 | 5.2 |
| | catalyst 2 | | | | | | | | | | | | |
| | Trimerization | 7.8 | 7.8 | 7.8 | 7.8 | 7.8 | 7.8 | 7.8 | 7.8 | 7.8 | 7.8 | 7.8 | 7.8 |
| | catalyst 1 | | | | | | | | | | | | |
| | Trimerization | 2.6 | 2.6 | 2.6 | 2.6 | 2.6 | 2.6 | 2.6 | 2.6 | 2.6 | 2.6 | 2.6 | 2.6 |
| | catalyst 2 | | | | | | | | | | | | |
| | Foaming agent 1 | — | — | — | — | — | — | 39.1 | — | — | — | — | — |
| | Foaming agent 2 | 27.4 | 33.2 | 39.1 | 27.4 | 27.4 | 27.4 | — | 24.4 | 27.4 | 27.4 | 39.1 | 39.1 |
| | Foaming agent 3 | — | — | — | — | — | — | — | 2.9 | — | — | — | — |
| | Water | 0.7 | 0.7 | 0.7 | 0.7 | 0.7 | 0.7 | 0.7 | 0.7 | 0.7 | 0.7 | 0.7 | 0.7 |
| | Foam stabilizing | 2.6 | 2.6 | 2.6 | 2.6 | 2.6 | 2.6 | 2.6 | 2.6 | 2.6 | 2.6 | 2.6 | 2.6 |
| | agent | | | | | | | | | | | | |
| Polyurethane | Solid content | 26.8 | 26.2 | 25.6 | 26.9 | 27.0 | 27.1 | 25.7 | 26.8 | 27.7 | 26.6 | 25.5 | 26.1 |
| composition | concentration | | | | | | | | | | | | |
| raw material | (% by mass) | | | | | | | | | | | | |
| liquid agent | Viscosity | 4644 | 3500 | 2400 | 5484 | 6500 | 8000 | 3200 | 5376 | 3100 | 1800 | 2000 | 230 |
| physical | (mPa · s) | | | | | | | | | | | | |
| properties | Room | A | B | B | A | A | A | B | A | B | C | C | C |
| Sedimentation | temperature | | | | | | | | | | | | |
| evaluation | Low | A | A | B | A | A | A | B | A | A | C | B | C |
| | temperature | | | | | | | | | | | | |

When the polyurethane composition raw material liquid agent of Comparative Examples 1 to 3, which had too low a viscosity, was stored at room temperature or low temperature for a long period of time, the filler sedimented at a lower portion of the cartridge-like container and did not uniformly disperse even when the cartridge-like container was manually shaken.

### REFERENCE SIGNS LIST

12 first cartridge-like container
14 second cartridge-like container
20 caulking gun
16 piston
18 stationary mixer
18A pipe
18B mixer element
18C tip
30, 32 cartridge-like container

1. A polyurethane composition raw material liquid agent, comprising a polyol or an isocyanate, and a filler,
the polyurethane composition raw material liquid agent having a viscosity at 25° C. and a rotation speed of 10 rpm of 2300 mPa·s or more, and
the polyurethane composition raw material liquid agent is filled in a cartridge-like container.

2. The polyurethane composition raw material liquid agent according to claim 1, further comprising an anti-sedimentation agent.

3. The polyurethane composition raw material liquid agent according to claim 2, wherein the anti-sedimentation agent includes an anti-sedimentation agent having a thickening action.

4. The polyurethane composition raw material liquid agent according to claim 1, wherein the filler includes a solid flame retardant.

5. The polyurethane composition raw material liquid agent according to claim 4, wherein the solid flame retardant is at least one selected from the group consisting of a red phosphorus flame retardant, a boron-containing flame retardant, a bromine-containing flame retardant, a phosphoric acid salt-containing flame retardant, a chlorine-containing flame retardant, an antimony-containing flame retardant, and a metal hydroxide.

6. The polyurethane composition raw material liquid agent according to claim 1, having a viscosity at 25° C. and a rotation speed of 10 rpm of 3300 mPa·s or more.

7. The polyurethane composition raw material liquid agent according to claim 1, having a viscosity at 25° C. and a rotation speed of 10 rpm of 4200 mPa·s or more.

8. A polyurethane composition formed from a reaction product of the polyurethane composition raw material liquid agent according to claim 1.

9. The polyurethane composition according to claim 8, wherein the polyurethane composition forms a polyurethane foam.

10. The polyurethane composition according to claim 8, wherein the polyurethane composition is used as a thermal insulator for a vehicle or a building.

11. A mixing and discharge system comprising:
a first cartridge-like container filled with the polyurethane composition raw material liquid agent according to claim 1; and
a second cartridge-like container filled with another polyurethane composition raw material liquid agent.

12. The mixing and discharge system according to claim 11, comprising a stationary mixer configured to mix the polyurethane composition raw material liquid agent discharged from the first cartridge-like container with the another polyurethane composition raw material liquid agent discharged from the second cartridge-like container.
